(19) United States
(12) Patent Application Publication
(10) Pub. No.: US 2005/0087143 A1
(43) Pub. Date: Apr. 28, 2005

(54) Pet pad with voice recorder and playback unit

(76) Inventor: Drew Doran, Peru, IN (US)

Correspondence Address: Frank D. Lachenmaier;Suite 200, 116 N. Main St., P.O. Box 1047, Kokomo, IN, 46903-1047, US

(21) Appl. No.: 10/692,565

(22) Filed: Oct. 24, 2003

(51) Int. Cl. A01K 1/035

(52) U.S. Cl. 119/28.5

(57) ABSTRACT

This invention generally relates to a mat or pad for a pet to lie on. More specifically this invention relates to a pet pad with a recorder and playback unit embedded within said pet pad such that each time the pet lies on the pad a prerecorded message from the pet's owner is played. The owner's voice heard each time the pet lies on its pad can be very comforting to a pet home alone or in a strange environment such as a kennel or veterinarian's office.

### FEDERALLY SPONSORED RESEARCH

Not Applicable

### Sequence Listing or Program

Not Applicable

### BACKGROUND

1. Field of Invention

This invention generally relates to pet comfort pads and more specifically to a pad for a pet to lie on that plays a comforting message in the owner's voice when the pet lies on the pad. The pet owner can record a comforting message on the recorder that is replayed each time the pet depresses the on-switch by lying on the pad.

2. Prior Art

The prior art discloses numerous playback and record systems. The use of pressure activated switches to trigger alarms or audio responses in toys or mats is also well documented. Programmable playback recorders have been used to amuse and educate children, call a pet at meal time or even act as a voice mail system for the front door of a home as opposed the conventional voice mail on a telephone system but none have combined these techniques to build a device that can comfort a pet during its many home alone periods or when it is forced to be away from home overnight.

Pet owners are concerned that they are often forced to leave pets home alone for long periods. Pets also are occasionally left for several days at veterinarian clinics, kennels or with friends or relatives. Many owners will leave an article with their scent on it with the pet to ease its anxiety from being in a strange place with strange people.

U.S. Pat. No. 6,369,698 Valente (2002) discloses a portable recorder with a comforting message to be replayed at fixed intervals during the day that can be in the shape of a telephone or dog bone or other pet toy. U.S. Pat. No. 4,551,713 Aossey (1985) disclosed a mat with a pressure activated buzzer embedded in the mat that was laid in front of a pet door to notify the owner when the pet left or returned. Conventional pet bedding is disclosed in U.S. Pat. No. 5,002,014 Albin (1991) and in U.S. Pat. No. 5,749,314 Pelham (1998).

U.S. Pat. No. 5,784,733 Rasamny (1998) shows a music producing device sewn into a child's blanket or garment with a switch that the child can activate for his own amusement. An educational mat is described in U.S. Pat. No. 5,971,761 Tillman (1999) with the alphabet and numbers printed on its top surface with each having a pressure pad behind it such that when pressure is applied to the individual character a recorded voice announces the correct pronunciation.

U.S. Pat. No. 6,000,987 Belin (1999) discloses children's dolls or other toys with replaceable voice activated speaking and recording mechanisms. U.S. Pat. No. 4,841,587 Carter (1989) shows a beach mat with an imbedded audio system.

U.S. Pat. No. 6,196,893 Casola (2001) discloses a record and playback mechanism for toys that features ability to record messages over the telephone as an option.

Finally U.S. Pat. No. 6,549,502 Lagasse (2003) discloses a welcome mat for outside the homeowner's door which has a playback and record voice-mail system triggered by stepping on the mat.

From the review above one can ascertain that each of the elements involved in the Pet Pad with Recorder and Playback Unit were disclosed in the prior art but the combination as in this invention was never taught in any of the previous patents.

Objects and Advantages

Accordingly several objects and advantages of the present invention are:
(a) to provide a pet pad that plays a recorded message in the pet owner's voice when the pet lies on the pad.
(b) to provide a pet pad that can travel with the pet to provide decreased anxiety for the pet while the owner and the pet are separated.
(c) to provide a pet pad that can be sized for different sized pets.
(d) to provide a pet pad that will protect the record and playback device from chewing by the pet.
(e) to provide pet pad with the playback and record device protected from moisture.
(f) to provide a pet pad of a soft and comfortable material.
(g) to provide a pet pad where batteries for the recorder and messages are easy to change.

Further objects and advantages will become apparent from a consideration of the ensuing description and drawings.

### SUMMARY

In accordance with the present invention, a pet pad with recorder and playback unit is comprised of recorder with a pressure activated playback unit inserted into a water tight pocket of a material heavy enough to avoid damage to the mechanism if the pet tries to chew on it, that is fixed within the pet pad itself with the pressure switch sensitive enough that the appropriate sized unit will be triggered to play the owner's message when the pet lies on the pad.

The foregoing and other objects and advantages will appear from the description to follow. Reference is made in the description to the accompanying drawings which form a part hereof. The accompanying drawings show, by way of illustration, a specific embodiment in which the invention is practiced whereby the pet pad with recorder and playback unit is approximately sized for an adult dog of approximately 30 lbs. The embodiment will be described in sufficient detail to enable those skilled in the art to practice the invention, and it is to be understood that other embodiments may be utilized and that structural changes may be made without departing from the scope of the invention. For example pads in different colors, shapes and materials might be utilized for different size or species of pet. The size and shape of the apparatus shown in the attached drawings is for illustrative purpose only and is not intended to limit the application as to scaling that will be obvious to one skilled in the art of pet pad design. In the accompanying drawings, like reference characters designate the same or similar parts throughout the several views.

### DRAWINGS

Drawing Figures

FIG. 1 shows a top view of the pet pad with a recorder and playback unit.

FIG. 2 shows a front view of the pet pad with a recorder and playback unit.

FIG. 3 shows a partial section view of the pet pad recorder and playback unit.

FIG. 4 shows a 4×enlarged view of the partial section of FIG. 3.

### Reference Numerals In Drawings

10—pet pad with a recorder and playback unit
12—pocket
14—recorder and playback unit
16—pet pad
18—pressure switch
20—top surface
22—overlapping slit
24—bottom surface

### DETAILED DESCRIPTION

In order that the invention may be more fully understood it will now be described, by way of example, with reference to the accompanying drawings in which Figures 1 through 4 illustrate a preferred embodiment of the present invention wherein pet pad with a recorder and playback unit 10 is disclosed.

Turning to FIG. 1, therein is shown pet pad with a recorder and playback unit 10 in a top view. This view discloses pet pad 16 sized for a dog of approximately 30 pounds that is approximately 43 cm.×70 cm. with top surface 20 pleasing to the pet and relatively easy to clean. Pet pad 16 has sufficient thickness to allow the pet to sleep comfortably on pet pad 16 in which recorder with playback unit 14 is embedded in pocket 12 in pet pad 16. Pocket 12 is made of plastic material of sufficient thickness as to protect recorder and playback unit 14 from damage if the pet tries to chew on it and is impervious to moisture.

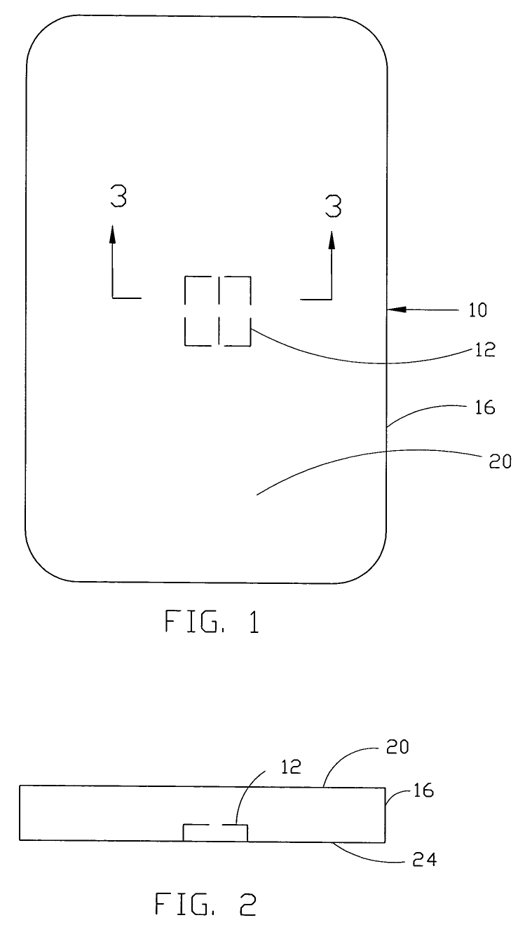

FIG. 2 shows a front view of pet pad with a recorder and playback unit 10 and embedded plastic pocket 12 hidden. FIG. 2 also illustrates top surface 20 and bottom surface 24.

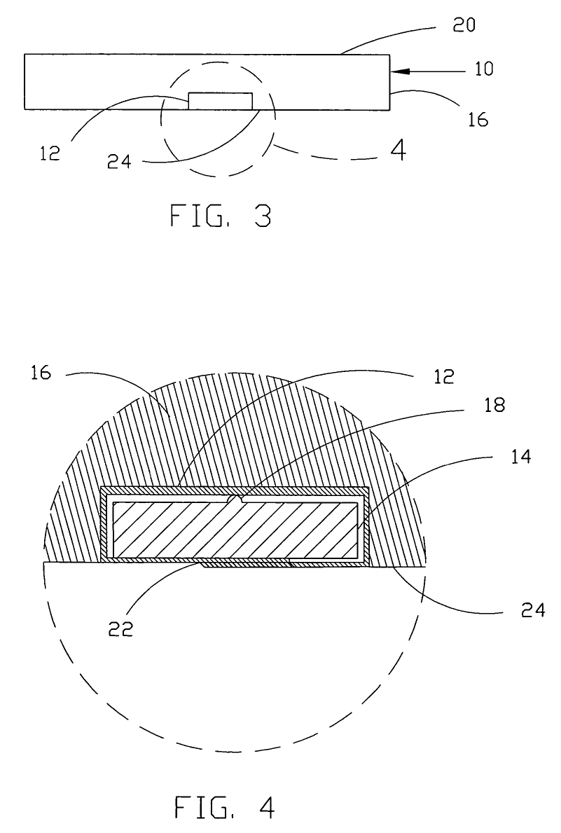

FIG. 3 show a partial section view in which recorder and playback unit 14 is shown embedded in pocket 12 and pressure switch 18 is located.

FIG. 4 shows a 4×view of the cross section 3-3 from FIG. 3 in which plastic pocket 12, embedded recorder and playback unit 14 and pressure switch 18 are located.

FIG. 4 also shows in cross-section 3-3 overlapping slit 22 through which recorder and playback unit 14 is inserted.

Operation

A comforting message is recorded on recorder and playback unit 14 and recorder and playback unit 14 is inserted through overlapping slit 22 into pocket 12 which has been fixably attached into bottom surface 24 of pet pad 16.

Each time the pet lies on pet pad with recorder and playback unit 10 it trips pressure switch 18 and a pre-recorded message plays on recorder and playback unit 14. Recorder and playback unit 14 then resets for the next time pressure switch 18 is triggered.

Accordingly pet pad with recorder and playback unit 10 provides:
(a) a pet pad that plays a recorded message in the pet owner's voice when the pet lies on the pad.
(b) a pet pad that can travel with the pet to provide decreased anxiety for the pet while the owner and the pet are separated.
(c) a pet pad that can be sized for different sized pets.
(d) a pet pad that will protect the record and playback device from chewing by the pet.
(e) a pet pad with the playback and record device protected from moisture.
(f) a pet pad of a soft and comfortable material.
(g) a pet pad where batteries for the recorder and messages are easy to change.

While I have explained my invention in detail with the aid of exemplary embodiment thereof, it will be understood that the invention is not limited to the specific constructional details shown and described by way of example, which may be departed from without departing from the scope and spirit of the invention and is only limited by the appended claims.

1. (canceled).

2. (canceled).

3. A pet pad with recorder and playback unit comprising:
(a) a pad of soft material sized to fit a particular pet having a top surface and a bottom surface, being generally flat and also a definite thickness;
(b) a heavy plastic pocket fixably attached inside said bottom surface of said pad with an overlapping slit opening;
(c) a record and playback unit inserted through said overlapping slit in said pocket comprising a voice recorder, a message player that has automatic shut-off and rewind capability after a message has been played, a pressure sensing switch for activating said message player each time a pet lies on said pet pad, a recording switch member to record new messages, and is battery powered, whereby a pet left alone at home or in a kennel or other strange surroundings can be comforted by the soothing effect of hearing a recording of his master's voice each time he lies on said pet pad.

4. A pet pad with recorder and playback unit as defined in claim 3 wherein said pet pad includes a removably disposed cover member that is easily removed for cleaning and wherein said pet pad's plastic pocket is heavy enough to prevent damage to said record and playback unit if the pet tries to chew on said pet pad with recorder and playback unit.
